(19) United States
(12) Patent Application Publication
(10) Pub. No.: US 2014/0225662 A1
(43) Pub. Date: Aug. 14, 2014

(54) LOW-VOLTAGE, HIGH-ACCURACY CURRENT MIRROR CIRCUIT

(71) Applicant: NVIDIA CORPORATION, Santa Clara, CA (US)

(72) Inventor: Yoshinori NISHI, San Jose, CA (US)

(73) Assignee: NVIDIA CORPORATION, Santa Clara, CA (US)

(21) Appl. No.: 13/764,464

(22) Filed: Feb. 11, 2013

(51) Int. Cl. G05F 1/10

(52) U.S. Cl. CPC G05F 1/10
USPC 327/539; 327/538; 327/543

(57) ABSTRACT

An approach is provided for a low-voltage, high-accuracy current mirror circuit. In one example, a current mirror circuit includes an input circuit configured to receive an input reference current. The input circuit includes a feedback channel for comparing and substantially matching the input reference current with an output current. The feedback channel is not configured for matching an input voltage with an output voltage. The input circuit does not include a comparator having an operational amplifier to compare the input reference current with the output current. The current mirror circuit also includes an output circuit coupled to the input circuit. The output circuit is configured to send the output current to one or more components of a circuit block.

### BACKGROUND OF THE INVENTION

1. Field of the Invention

The present invention generally relates to integrated circuits, and, more specifically, to a low voltage, high-accuracy current mirror circuit design.

2. Description of the Related Art

An integrated circuit typically includes components (e.g., buffers, amplifiers, flip-flops, etc.) that operate based on a bandgap voltage reference. A bandgap voltage reference is a temperature-independent voltage reference circuit widely used in integrated circuits. There may be hundreds of components that operate based on one bandgap voltage reference within a given circuit because a bandgap circuit requires significant silicon area. Typically, each component receives the information of the bandgap voltage reference over a long distance (e.g., 2 mm). If voltage is used to deliver such information over a long distance, it is difficult to ensure the same ground potential against which the bandgap voltage is measured and converted to current. Further, such voltage to current conversion is costly in terms of silicon area. If current is used for delivering the information, then the current requires point-point connections, thereby requiring many current connections to run over a long distance. Such connections are also costly in terms of the silicon area.

Accordingly, what is needed in the art is a more optimized way of providing a reference current to multiple components within an integrated circuit.

### SUMMARY OF THE INVENTION

One implementation of the present approach includes a low-voltage, high-accuracy current mirror circuit. The current mirror circuit includes an input circuit configured to receive an input reference current, wherein the input circuit includes a feedback channel for comparing and substantially matching the input reference current with an output current, and wherein the feedback channel is not configured for matching an input voltage with an output voltage, and wherein the input circuit does not include a comparator having an operational amplifier to compare the input reference current with the output current; and an output circuit coupled to the input circuit, wherein the output circuit is configured to send the output current to one or more components of a circuit block.

Advantageously, the disclosed approach consumes a small amount of area on an integrated circuit chip. For example, the feedback channel enables the current mirror circuitry to stabilize easily (e.g., easily match an input current with an output current without causing oscillatory behavior), and do so at a low cost (e.g., without large components, such as operational amplifiers, that take up a lot of space or that are relatively expensive monetarily).

### BRIEF DESCRIPTION OF THE DRAWINGS

So that the manner in which the above recited features of the present invention can be understood in detail, a more particular description of the invention, briefly summarized above, may be had by reference to implementations, some of which are illustrated in the appended drawings. It is to be noted, however, that the appended drawings illustrate only typical implementations of this invention and are therefore not to be considered limiting of its scope, for the invention may admit to other equally effective implementations.

FIG. 1 is a block diagram illustrating a computer system configured to implement one or more aspects of the present invention.

FIG. 2 is a block diagram of a conventional analog/mixed-signal physical layer (PHY) integrated circuit.

FIG. 3A is a circuit diagram of a conventional analog/mixed-signal physical layer (PHY) integrated circuit.

FIG. 3B is a circuit diagram of another conventional analog/mixed-signal physical layer (PHY) integrated circuit.

FIG. 4 is a circuit diagram of an analog/mixed-signal physical (PHY) integrated circuit, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

### System Overview

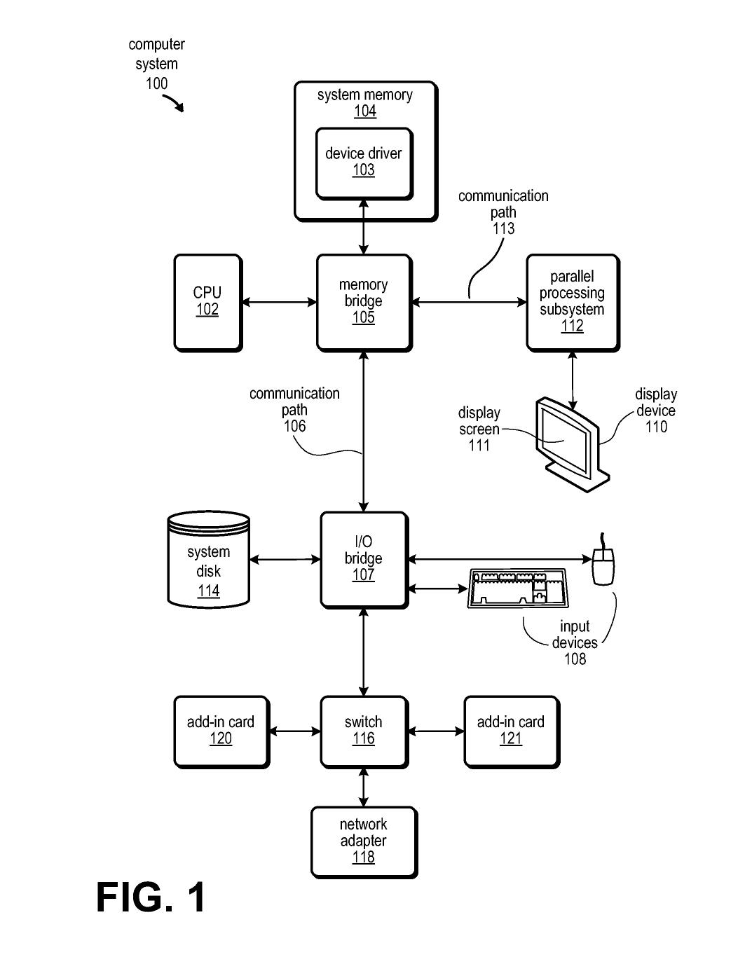

FIG. 1 is a block diagram illustrating a computer system 100 configured to implement one or more aspects of the present invention. Computer system 100 includes a central processing unit (CPU) 102 and a system memory 104 that includes a device driver 103. CPU 102 and system memory 104 communicate via an interconnection path that may include a memory bridge 105. Memory bridge 105, which may be, for example, a Northbridge chip, is connected via a bus or other communication path 106 (e.g., a HyperTransport link, etc.) to an input/output (I/O) bridge 107. I/O bridge 107, which may be, for example, a Southbridge chip, receives user input from one or more user input devices 108 (e.g., keyboard, mouse, etc.) and forwards the input to CPU 102 via path 106 and memory bridge 105.

As also shown, a parallel processing subsystem 112 is coupled to memory bridge 105 via a bus or other communication path 113 (e.g., a peripheral component interconnect (PCI) express, Accelerated Graphics Port (AGP), and/or HyperTransport link, etc.). In one implementation, parallel processing subsystem 112 is a graphics subsystem that delivers pixels to a display device 110 (e.g., a conventional cathode ray tube (CRT) and/or liquid crystal display (LCD) based monitor, etc.). A system disk 114 is also connected to I/O bridge 107. A switch 116 provides connections between I/O bridge 107 and other components such as a network adapter 118 and various add-in cards 120 and 121. Other components (not explicitly shown), including universal serial bus (USB) and/or other port connections, compact disc (CD) drives, digital video disc (DVD) drives, film recording devices, and the like, may also be connected to I/O bridge 107. Communication paths interconnecting the various components in FIG. 1 may be implemented using any suitable protocols, such as PCI, PCI Express (PCIe), AGP, HyperTransport, and/or any other bus or point-to-point communication protocol(s), and connections between different devices that may use different protocols as is known in the art. A device is hardware or a combination of hardware and software. A component is also hardware or a combination of hardware and software.

In one implementation, the parallel processing subsystem 112 incorporates circuitry optimized for graphics and video processing, including, for example, video output circuitry, and constitutes a graphics processing unit (GPU). In another implementation, the parallel processing subsystem 112 incorporates circuitry optimized for general purpose processing, while preserving the underlying computational architecture, described in greater detail herein. In yet another implementation, the parallel processing subsystem 112 may be integrated with one or more other system elements, such as the memory bridge 105, CPU 102, and I/O bridge 107 to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For instance, in some implementations, system memory 104 is connected to CPU 102 directly rather than through a bridge, and other devices communicate with system memory 104 via memory bridge 105 and CPU 102. In other alternative topologies, parallel processing subsystem 112 is connected to I/O bridge 107 or directly to CPU 102, rather than to memory bridge 105. In still other implementations, I/O bridge 107 and memory bridge 105 might be integrated into a single chip. Large implementations may include two or more CPUs 102 and two or more parallel processing systems 112. The particular components shown herein are optional; for instance, any number of add-in cards or peripheral devices might be supported. In some implementations, switch 116 is eliminated, and network adapter 118 and add-in cards 120, 121 connect directly to I/O bridge 107.

### Overview of an Analog/Mixed-Signal Physical Layer (PHY) Circuit

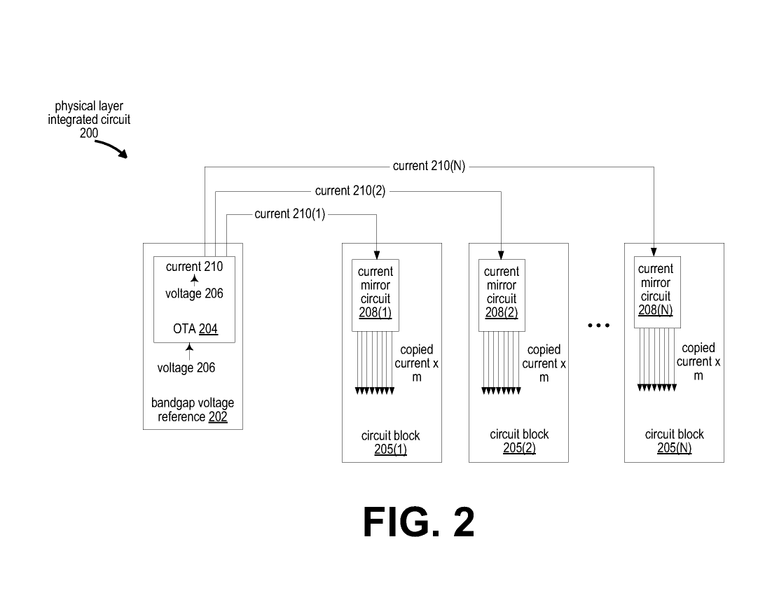

FIG. 2 is a block diagram of a conventional analog/mixed-signal physical layer integrated circuit 200 (PHY 200). The PHY 200 includes a bandgap voltage reference couple to circuit blocks 205, including a circuit block 205(1), circuit block 205(2), . . . , and circuit block 205(N), where N≧1. The bandgap voltage reference includes an operational transconductance amplifier (OTA) 204. Each of the circuit blocks 205 includes a current mirror circuit 208 of like reference numeral. For example, the circuit block 205(1) includes a current mirror circuit 208(1), and so on.

The bandgap voltage reference 202 is a temperature independent voltage reference circuit. In a standard analog/mixed-signal PHY 200, typically just one bandgap voltage reference 202 is on the integrated circuit to generate a reference voltage 206. The limit to just one bandgap voltage reference 202 is due to the fact that a bandgap voltage reference 202 occupies a large area on an integrated circuit. Typically, the bandgap voltage reference 202 is a few hundred times larger in area than a current mirror circuit 208. The OTA 204 is an amplifier whose differential input voltage produces an input reference current. The OTA 204 is a voltage controlled current source (VCCS).

Accordingly, the PHY 200 is configured to convert the reference voltage 206 to an input reference current, including input reference current 210(1), input reference current 210(2), . . . , and input reference current 210(N), where N≧1. The input reference currents are then distributed over long distances. Each input reference current corresponds to a circuit block 205 of like reference numeral. For example, the input reference current 210(1) corresponds the circuit block 205(1), and so on.

A purpose of such current distribution is to avoid having a large OTA circuit on the PHY 200 at every instance the integrated circuit is configured to convert the reference voltage 206 to an input reference current 210 for a destination circuit block 205. Alternatively, an integrated circuit may be configured to convert the reference voltage 206 to another form of voltage such as a gate-source voltage V_{gs} of a shorted transistor in order to enable the type of one-to-multipoint distribution illustrated in FIG. 1. However, such a configuration results in substantial inaccuracies at the current mirrors 208 due to on-chip variations over a long distance (e.g., 2 mm). Furthermore, even if the distribute bandgap voltage is distributed over the long distance and a large OTA is used to convert the bandgap voltage to a current, the scheme suffers from inaccuracy because the base voltage level, which is the ground potential for most cases, could be different at a distant destination and such difference leads to a distributed reference voltage that is interpreted with error.

After each circuit block 205 receives a input reference current, each circuit block 205 is configured to copy the input reference current to regenerate multiple instances of the same input reference current in order to bias block components (e.g., buffers, amplifiers, flip-flops, etc.) However, sending N×m reference currents from the bandgap voltage reference 202 directly would be troublesome since N×m could exceed 100 in many configurations.

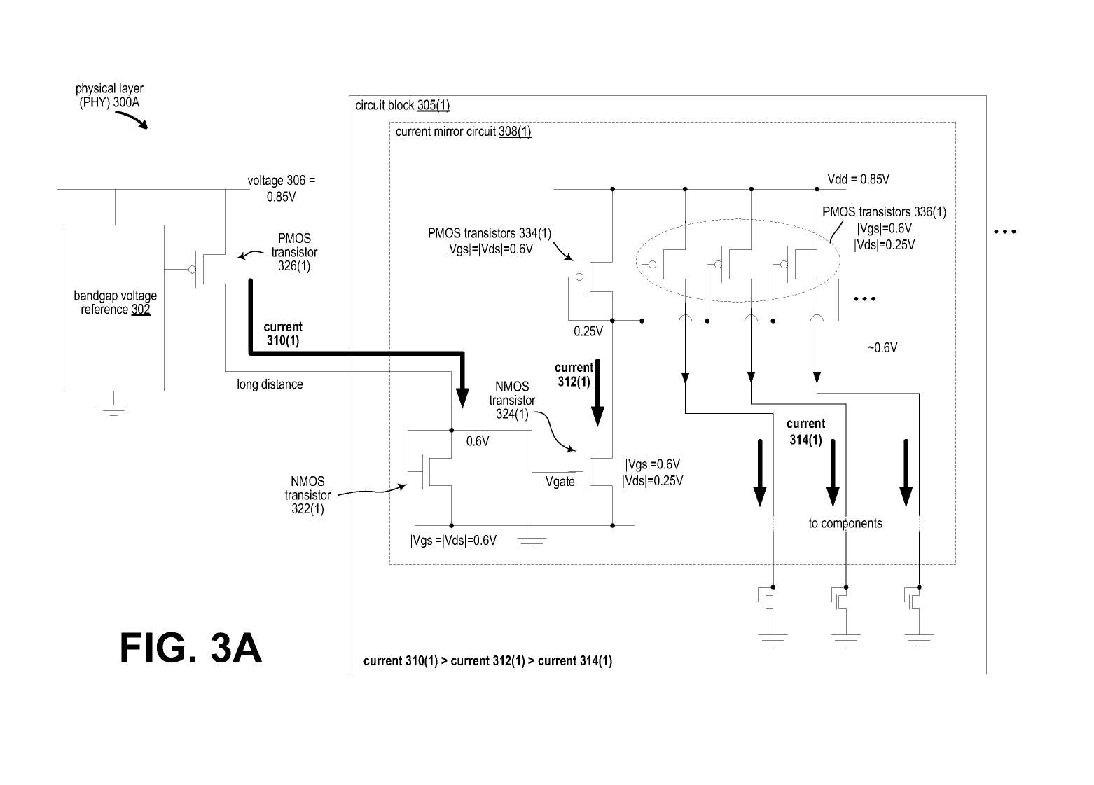

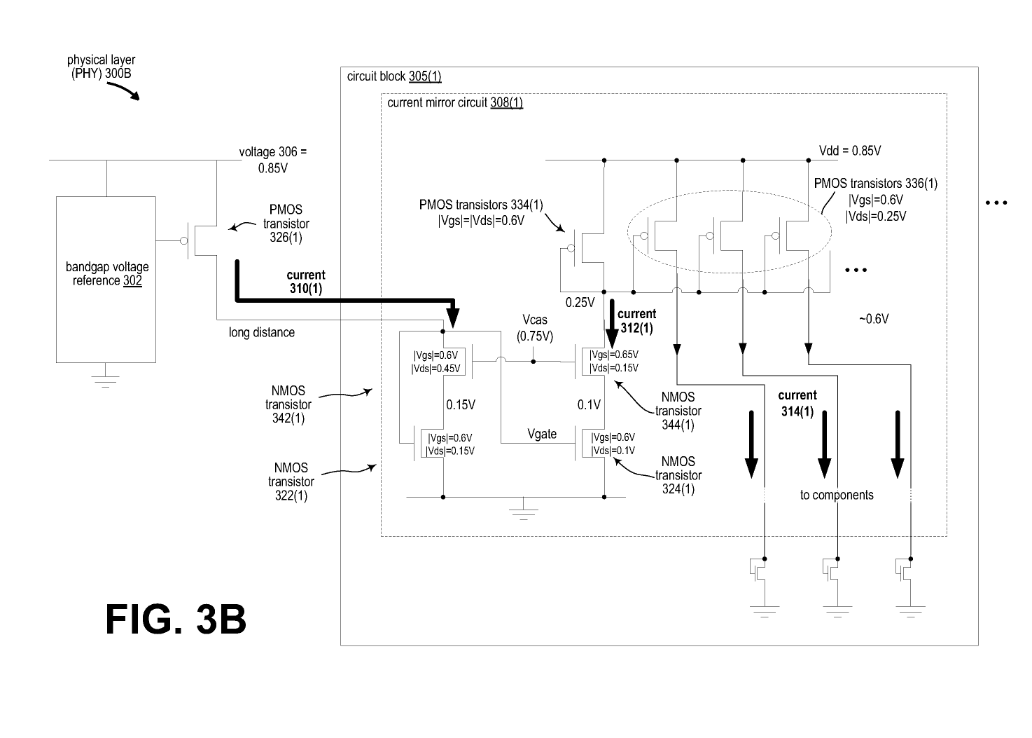

As explained above, current mirror circuits (e.g., current mirror circuits 208) are highly important in an analog/mixed signal PHY (e.g., PHY 200) where the PHY uses many circuit blocks (e.g., circuit blocks 205). However, each current mirror circuit suffers from severe drawbacks when the power supply voltage is very low, as further explained below with reference to FIG. 3A.

FIG. 3A is a circuit diagram of a conventional analog/mixed-signal physical layer integrated circuit (PHY 300A). The PHY 300A includes a bandgap voltage reference 302 couple to one or more circuit blocks, including circuit block 305(1). Other circuit blocks (e.g., circuit block 305(2) through circuit block 305(N)) are not shown for the sake of simplicity. Each of the circuit blocks includes current mirror circuits of like reference numeral. For example, the circuit block 305(1) includes current mirror circuit 308(1), and so on. A PMOS transistor is a p-type metal-oxide-semiconductor field-effect transistor, and a NMOS transistor is an n-type metal-oxide-semiconductor field-effect transistor.

In this example of FIG. 3A, the bandgap voltage reference 302 is fed to an OTA that includes a PMOS transistor 326(1). The PMOS transistor 326(1) has a drain that shares a node with a drain of an NMOS transistor 322(1) and with a gate of an NMOS transistor 324(1). A drain of the NMOS transistor 324(1) shares a node with a gate and a drain of a PMOS transistor 334(1), and with gates of one or more cascaded PMOS transistors 336(1). A source of the PMOS transistor 334(1) and each source of the PMOS transistors 336(1) share a node at a power supply configured to operate at a supply voltage V_{dd}. Each drain of the other cascaded PMOS transistors 336(1) is coupled to a component of the circuit block 305(1). The gate of the NMOS transistor 324(1) shares a node with a gate of the NMOS transistor 322(1). A source of the NMOS transistor 324(1), and a source of the NMOS transistor 322(1) share a ground.

Complementary metal-oxide-semiconductor (CMOS) technology may require the supply voltage V_{dd} to decrease to a low-voltage. In FIG. 3A, a low-voltage is illustrated as being 0.85 V. In another example, a low-voltage may include a voltage that is less than approximately 2 V, or another voltage value that is considered low-voltage for the particular circuitry. Referring again to FIG. 3A, a threshold voltage of a component (e.g., one component in FIG. 3A) may be still in a range of 400 mV to 500 mV, for example. The threshold voltage is the gate voltage at which an inversion layer forms at the interface between the insulating layer (e.g., oxide) and the substrate (e.g., body) of the transistor. The formation of the inversion layer allows the flow of electrons through the gate-source junction.

The input reference current 310(1) is typically copied by using a diode-connected transistor 322(1) whose gate and drain are shorted. By using this configuration, the regenerated current 312(1) is always lower than the input reference current 310(1) because the drain-source V_{ds} of the NMOS transistor 322(1) is always lower after the copy. For example, each gate-source voltage of NMOS transistor 322(1) and NMOS transistor 324(1) is 0.6V, but the drain-source voltage V_{ds} of NMOS transistor 322(1) is 0.6V versus 0.2V for the drain-source voltage V_{ds} of NMOS transistor 324(1). This voltage difference could lead, for example, to 5 to 10% reduction in current where severe channel-length modulation occurs Channel length modulation is the effect more pronounced in recent submicron CMOS technologies when short gate channel length is used, causing output impedance of transistors to drop significantly. Transistors are expected to behave as constant current source when sufficient drain to source voltage is given. However, with channel length modulation such sufficient drain voltage does not ensure constant current. For example, threshold voltage Vth=0.5V, gate-source voltage Vgs=0.6V, drain-source voltage Vds=0.25V vs. 0.6V, could lead to more than 10% current mismatch. Further, in each component (e.g., amplifier, sampler, multiplexer, mixer, voltage controlled oscillator, an input/output device, etc.) of the circuit block 305(1), the output current 314(1) is received by a diode-connected NMOS, as shown in the FIG. 3A, resulting in the same V_{ds} mismatch of 0.6V versus 0.25V at the output PMOS. As a consequence, the output current 314(1) may be as low as −20% of the input reference current 310(1) by the time the output current 314(1) is used in each component. As explained below with reference to FIG. 3B, a conventional solution is to use a cascade current mirror.

FIG. 3B is a circuit diagram of another conventional analog/mixed-signal physical layer integrated circuit (PHY 300B). FIG. 3B is similar to FIG. 3A but with additions of NMOS transistor 342(1) and NMOS transistor 344(1). The NMOS transistors (342(1), 322(1), 344(1), and 324(1)) are arranged in a cascode current mirror, which can mitigate the reduction of the copied input reference current. The word “cascode” is a contraction of the phrase “cascade to cathode”. A cascode current mirror is a conventional technique to stack two pairs of transistors and use one of the transistor pairs to control the drain voltage of the current source. For example, in FIG. 3B, transistor 342(1) is inserted between the gate and drain of transistor 322(1), and another transistor 344(1) is inserted between the drain of transistor 324(1) and drain of transistor 334(1). The two inserted cascode transistors (342(1) and 344(1)) have the common gate voltage controlling the drain voltages of 322(1) and 324(1). However, it is difficult to operate cascode components with a large drain-source voltage. For example, transistor 324(1) with the cascode device on top has 0.25V at the drain, and this 0.25V needs to be shared between 324(1) and the cascade device on top. In such a configuration, the drain-source voltages of transistor 322(1) and transistor 324(1) are both pushed down to linear region (e.g., “triode mode” or “ohmic mode”). (Compare to FIG. 3A.) A linear region is an operating mode where the gate-source voltage is greater than the threshold voltage, and where the drain-source voltage is less than the difference between the gate-source voltage and the threshold voltage. In the linear region, transistors act as resistors, and current varies greatly with the drain voltage, thereby making the transistors unsuitable to be current sources. One could alternatively use an operational amplifier (not shown) to match accurately the drain-source voltage V_{ds} of two current sources. However, using an operational amplifier for every current mirror is very costly since an operational amplifier consumes a large area, especially with a compensation capacitance to stabilize feedback.

Accordingly, a circuit is provided below to operate at a low voltage and to mirror accurately a reference current of an integrated circuit, without being overly costly.

### Low Voltage, High-Accuracy Current Mirror Circuit

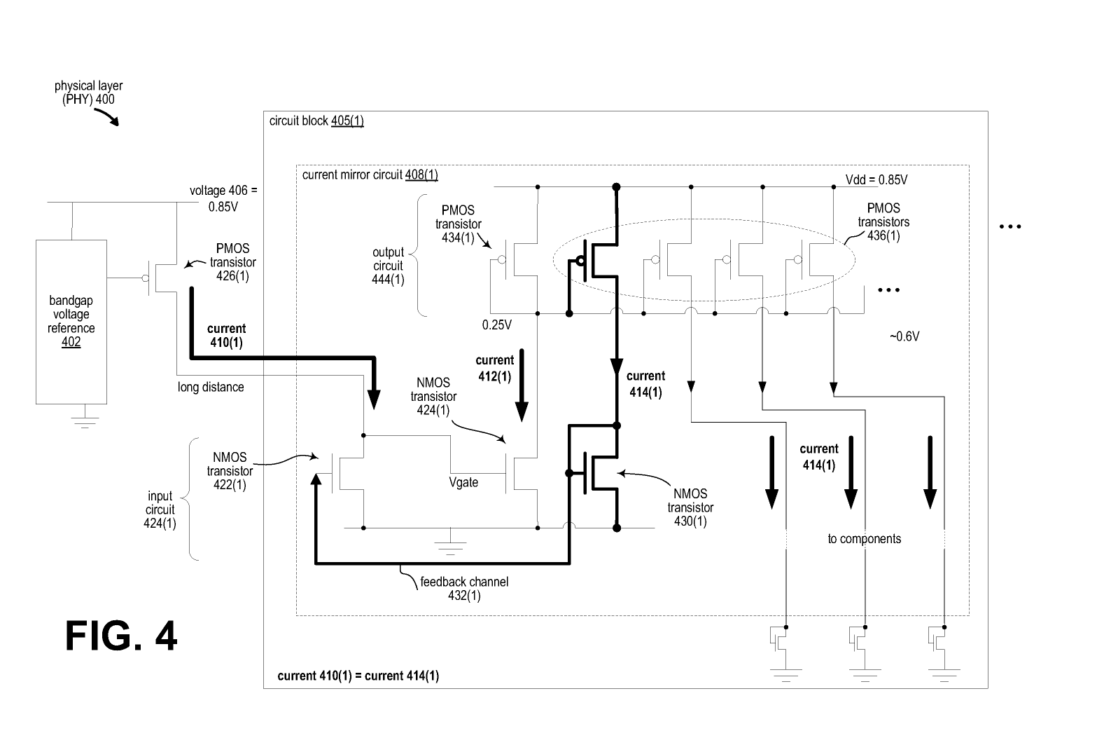

FIG. 4 is a circuit diagram of an analog/mixed-signal physical integrated circuit (PHY 400), according to one embodiment of the present invention. The PHY 400 includes a bandgap voltage reference 402 couple to one or more circuit blocks, including circuit block 405(1). Other circuit blocks (e.g., circuit block 405(2) through circuit block 405(N)) are not shown for the sake of simplicity. Each of the circuit blocks includes current mirror circuits of like reference numeral. For example, the circuit block 405(1) includes current mirror circuit 408(1), and so on.

In this example of FIG. 4, the current mirror circuit 408(1) includes an input circuit 424(1) coupled to an output circuit 444(1). The input circuit 424(1) includes an NMOS transistor 422(1), an NMOS transistor 424(1), and an NMOS transistor 430(1). The bandgap voltage reference 402 is coupled to a PMOS transistor 426(1). The PMOS transistor 426(1) has a drain (e.g., input reference current 410(1)) that is coupled to a drain of the NMOS transistor 422(1) and with a gate of the NMOS transistor 424(1).

The output circuit 444(1) includes a PMOS transistor 434(1) and cascaded PMOS transistors 436(1). A drain of the NMOS transistor 424(1) is coupled to a gate and a drain of the PMOS transistor 434(1), and with gates of the cascaded PMOS transistors 436(1). A source of the PMOS transistor 434(1) and each source of the cascaded PMOS transistors 436(1) are coupled at a power supply configured to operate at a supply voltage V_{dd}. A drain of one of the cascaded PMOS transistors 436(1) is coupled to a drain of an NMOS transistor 430(1) of the input circuit 424(1). Each drain of the other cascaded PMOS transistors 436(1) is coupled to a component of the circuit block 405(1). The gate of the NMOS transistor 430(1) is coupled to a node with a gate of the NMOS transistor 422(1). A source of the NMOS transistor 430(1), a source of the NMOS transistor 424(1), and a source of the NMOS transistor 422(1) are coupled to a ground.

In the PHY 400 of FIG. 4, the transistors are labeled as being either NMOS or PMOS. However, the approach is not so limited. In an alternative example, an NMOS-labeled transistor may instead be a PMOS transistor, and a PMOS-labeled transistor may instead by an NMOS transistor, with appropriate circuit connections that are known to one skilled in the art.

A purpose of the current mirror circuit 408(1) is to have the output current 414(1) match with (e.g., be substantially equal to) the input reference current 410(1). Accordingly, the current mirror circuit 408(1) is configured to compares the output current 414(1) with the input reference current 410(1) by adding another current mirror including the NMOS transistor 430(1). By coupling the gates the NMOS transistor 430(1) and the NMOS transistor 422(1), the NMOS transistor 430(1) is configured to provide a feedback channel 432(1) to the input NMOS transistor 422(1).

Feedback channel 432(1) naturally enables the input circuit 424(1) to operate as a high-gain, trans-impedance amplifier (e.g., current 410(1) in, V_{gate} out) with only one high-impedance node at the gate of the NMOS transistor 424(1). Such a configuration of the feedback channel 432(1) enables the current mirror circuit 408(1) to stabilize easily the input reference current 410(1) with the output current 414(1). For example, with the feedback channel 432(1), the current mirror circuit 408(1) is configured to match (e.g., equalize substantially) the input reference current 410(1) with the output current 414(1), with high-accuracy and at a low-voltage (e.g., reference voltage 406=V_{dd}=0.85 V). With the feedback channel 432(1), it does not matter whether or not the current 412(1) coming from the drain of the PMOS transistor 434(1) is equivalent to the input reference current 410(1). Likewise, with the feedback channel 432(1), it does not matter whether or not there is current leakage from the gates of the cascaded PMOS transistors 436(1).

In one example simulation of the PHY 400, the current mirror circuit 408(1) can receive an input reference current 410(1) of 100 μA, and then make copy to generate a output current 414(1) of 100 pA. In contrast, under the substantially same conditions, a standard cascode component (not shown) may receive an input reference current of 100 pA and then generate a mismatched output current of 85 pA for example due to aforementioned low drain voltage to push transistors into linear region. While this mismatch is deterministic, accuracy of the current mirror circuit 408(1) is dependent substantially only on random device mismatches (e.g., mismatches due to manufacturing defects and/or tolerance limitations), assuming there is no systematic offset among the transistors.

Advantageously, the solution described with reference to FIG. 4 is a low-cost solution to the issues discussed above with reference to FIGS. 2 and 3. For example, the configuration of FIG. 4 enables the current mirror circuitry to stabilize easily (e.g., easily match an input current with an output current without causing oscillatory behavior), and do so at a low cost (e.g., without large components, such as additional operational amplifiers, that take up a lot of space).

The invention has been described above with reference to specific implementations. Persons skilled in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

The invention claimed is:

1. A current mirror circuit, comprising:
an input circuit configured to receive an input reference current, wherein the input circuit includes a feedback channel for comparing and substantially matching the input reference current with an output current, and wherein the feedback channel is not configured for matching an input voltage with an output voltage, and wherein the input circuit does not include a comparator having an operational amplifier to compare the input reference current with the output current; and
an output circuit coupled to the input circuit, wherein the output circuit is configured to send the output current to one or more components of a circuit block.

2. The current mirror circuit of claim 1, wherein the input reference current is received from a transistor that is coupled to a bandgap voltage reference.

3. The current mirror circuit of claim 1, wherein input circuit includes:
a first transistor;
a second transistor having a gate that is coupled to a drain of the first transistor, and wherein the input reference current is received at the drain of the first transistor; and
a third transistor having a gate that is coupled to a gate of the first transistor.

4. The current mirror circuit of claim 3, wherein the feedback channel includes the gate of the third transistor coupled to the gate of the first transistor.

5. The current mirror circuit of claim 3, wherein each of the first transistor, the second transistor, and the third transistor comprises an NMOS transistor.

6. The current mirror circuit of claim 3, wherein a source of the first transistor, a source of the second transistor, and a source of the third transistor are coupled to a ground.

7. The current mirror circuit of claim 3, wherein the output circuit includes a fourth transistor having a gate and a drain that both are coupled to a drain of the second transistor of the input circuit.

8. The current mirror circuit of claim 7, wherein the output circuit further includes two or more cascaded transistors, wherein a gate of each cascaded transistor is coupled to the gate of the fourth transistor, and wherein a drain of one of the cascaded transistors is coupled to a drain of the third transistor of the input circuit.

9. The current mirror circuit of claim 8, wherein each of the fourth transistor and the two or more cascaded transistors comprises a PMOS transistor.

10. The current mirror circuit of claim 9, wherein at least one drain of one of the cascaded transistors is coupled to a component of the circuit block and is configured to send the output current to the component.

11. The current mirror circuit of claim 3, wherein the feedback channel configures the input circuit to have only one high-impedance node at the gate of the second transistor.

12. The current mirror circuit of claim 1, wherein the feedback channel configures the input circuit to match the input reference current with the output current.

13. An integrated circuit, comprising:
a bandgap voltage reference; and
at least one circuit block coupled to the bandgap voltage reference, wherein each circuit block includes one or more circuit block components and a current mirror circuit coupled to the one or more circuit block components, wherein each current mirror circuit includes an input circuit and an output circuit, wherein each input circuit is configured to receive an input reference current, and wherein each input circuit includes a feedback channel for comparing and substantially matching the input reference current with an output current, and wherein the feedback channel is not configured for matching an input voltage with an output voltage, and wherein the input circuit does not include a comparator having an operational amplifier to compare the input reference current with the output current, and wherein each output circuit is coupled to the input circuit, and wherein each output circuit is configured to send the output current to the one or more components of the circuit block.

14. The integrated circuit of claim 13, wherein the integrated circuit includes at least one of an analog physical layer (PHY), or a mixed-signal physical layer.

15. The integrated circuit of claim 13, wherein the one or more components of each circuit block include at least one of an amplifier, a sampler, a multiplexer, a mixer, a voltage controlled oscillator, or an input/output device.

16. The integrated circuit of claim 13, wherein the input reference current is received from a transistor that is coupled to the bandgap voltage reference.

17. The integrated circuit of claim 13, wherein the input circuit includes:
a first transistor;
a second transistor having a gate that is coupled to the input reference current
and a drain of the first transistor; and
a third transistor having a gate that is coupled to a gate of the first transistor.

18. The integrated circuit of claim 17, wherein the feedback channel includes the gate of the third transistor coupled to the gate of the first transistor.

19. The integrated circuit of claim 17, wherein each current mirror circuit is configured to operate at a supply voltage of less than approximately 2 volts.

20. A computing device, comprising:
at least one integrated circuit including a bandgap voltage reference and at least one circuit block coupled to the bandgap voltage reference,
wherein each circuit block includes one or more circuit block components and a current mirror circuit coupled to the one or more circuit block components, wherein each current mirror circuit includes an input circuit and an output circuit, wherein each input circuit is configured to receive an input reference current, and wherein each input circuit includes a feedback channel for comparing and substantially matching the input reference current with an output current, and wherein the feedback channel is not configured for matching an input voltage with an output voltage, and wherein the input circuit does not include a comparator having an operational amplifier to compare the input reference current with the output current, and wherein each output circuit is coupled to the input circuit, and wherein each output circuit is configured to send the output current to the one or more components of the circuit block.
